(19) United States
(12) Patent Application Publication
(10) Pub. No.: US 2026/0195792 A1
(43) Pub. Date: Jul. 9, 2026

(54) METHOD AND SYSTEM FOR ESTIMATING IMPACT OF CAMPAIGNS

(71) Applicant: Accenture Global Solutions Limited, Dublin (IE)

(72) Inventors: Govindarajan JK, Bangalore (IN); Shikha SINGH, Allahabad (IN); Deepak PANDEY, New Delhi (IN); Georgios PASSALIS, Vrilissia (GR)

(73) Assignee: Accenture Global Solutions Limited, Dublin (IE)

(21) Appl. No.: 19/013,168

(22) Filed: Jan. 8, 2025

(51) Int. Cl. G06Q 30/0242

(52) U.S. Cl. CPC G06Q 30/0242

(57) ABSTRACT

Method, system, and computer-readable media for estimating long-term and short-term values of campaign. Churn customers from various customers and expected time for chum customers to chum from system is identified, based on data corresponding to various dimensions. Data subsets from data is generated. Respective score for each data subset is generated by processing each data subset using statistical model or machine-learning based model. Survival probability of each customer is computed based upon weighted average score generated from respective score for each data subset. Respective long-term value of each customer is determined based on survival probability, historical value, and discount factor. Customers are classified into groups of customers for campaign by client based on the LTV of each customer. Budget of campaign is identified based on groups of customers, and various factors. Long-term value and short-term value of campaign are estimated based upon budget and groups of customers.

### TECHNICAL FIELD

Various examples described herein relate generally to computer-implemented method, computer system, and computer program product for estimating a long-term value as well a short-term value indicating a long-term impact and a short-term impact of a campaign.

### BACKGROUND

Campaigns are coordinated, and strategic efforts designed by organizations to promote a product, a service, and/or a brand and engage target audience (potential customers and/or existing customers). The campaigns typically use various channels, such as digital advertising, email marketing, social media, events, and/or traditional media, to reach their target audience. A primary goal of a campaign is to influence customer behavior, drive awareness, generate leads, increase sales, and/or foster brand loyalty. Depending on an objective, the campaign may be a short-term campaign, focused on immediate sales or promotions (like seasonal discounts or product launches), or a long-term campaign, aimed at building sustained customer relationships, brand equity, and/or engagement over time. The campaign may be highly tailored, often segmenting audiences based on demographics, purchasing history, or behaviors to create personalized experiences. For example, a retail campaign may involve sending targeted offers to frequent shoppers or launching seasonal sales that appeal to specific customer needs. With rise of digital initiatives, the campaigns have become increasingly data-driven, leveraging customer insights, social media interactions, and online behaviors to optimize and refine messaging, timing, and outreach.

### SUMMARY

Implementations of the present disclosure are generally directed to estimating long-term and short-term values of campaigns. More particularly, implementations of the present disclosure are directed to enabling identification of customers' survival probability and estimating a long-term value impact of the campaigns on targeted customers by analyzing data across multiple dimensions and generating respective scores using statistical models and/or machine-learning models. Due to which, prediction of the long-term values of the campaigns and effectiveness of customer retention strategies may be improved.

In general, innovative aspects of the subject matter described in this specification provide a computer-implemented method for estimating a long-term and short-term values of a campaign. The method may include identifying, based on data corresponding to a plurality of dimensions, churn customers from a plurality of customers and expected time for the churn customers to churn from a system. The method may include generating a plurality of data subsets from the data corresponding to the plurality of dimensions. The method may further include generating a respective score for each data subset of the plurality of data subsets by processing the each data subset using at least one statistical and/or machine-learning based model for analyzing survival aspect of the each customer of the plurality of customers. The at least one statistical model and/or the machine-learning based model may be trained based on the identified churn customers and expected time for the churn customers. The method may further include computing a survival probability of each customer of the plurality of customers based upon a weighted average score. The weighted average score may be generated from the respective score for each data subset. The method may include determining a value of a respective long-term value (LTV) of each customer of the plurality of customers based on the survival probability of the each customer, a historical value, and a discount factor. The method may include classifying, based on the LTV of the each customer, the plurality of customers into one or more groups of customers for a campaign by a client. Each of the one or more groups of customers is related to a theme. The method may include identifying a budget of the campaign, based on the one or more groups of customers, and a plurality of factors. The method may include estimating, based upon the identified budget and the one or more groups of customers, a long-term value and a short-term value of the campaign.

The present disclosure further describes a system for implementing the method provided herein. The present disclosure also describes computer-readable media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example environment that may be used to execute implementations of the present disclosure.

FIG. 2 illustrates a block diagram of a system for estimating long-term and short-term values of a campaign, in accordance with implementations of the present disclosure.

FIG. 3 illustrates an example scenario of training an ensemble model for computing survival probabilities of customers, in accordance with implementations of the present disclosure.

FIG. 4 illustrates an example scenario of generating a weighted average score from respective scores for data subsets using a survival simulator, in accordance with implementations described in this disclosure.

FIG. 5 illustrates an example table representing determination of a total net present value (NPV) for a customer for a predefined time period, in accordance with implementations of the present disclosure.

FIG. 6 illustrates an example process flow of classifying customers into one or more groups of customers based on prioritization, in accordance with implementations of the present disclosure.

FIG. 7 illustrates an example process flow of classifying customers into one or more groups of customers based on differential treatment, in accordance with implementations of the present disclosure.

FIG. 8 illustrates an example graph representing value change of customers over time during a campaign, in accordance with implementations of the present disclosure.

FIG. 9 is a flow diagram that presents an example method for estimating a long-term value and a short-term value of a campaign, in accordance with implementations of the present disclosure.

FIG. 10 illustrates a computer system that may be used to implement a survival estimation system.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same examples, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of an example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope of the disclosure as set forth in the claims.

As organizations operate in increasingly competitive markets, an ability to design, execute, and measure a success of campaigns has become crucial for driving growth of the organizations and sustaining customer loyalty. To effectively assess the success of the campaigns, the organizations need to evaluate not only immediate impact (e.g., short-term value) of the campaigns but also a long-term value of the campaigns. Understanding the long-term value of the campaigns is essential for gaining insights into how the campaigns influence customer behavior, retention, and overall lifetime value. Further, a long-term value analysis for estimating the long-term impact of the campaigns focuses on tracking sustained effects of the campaigns, such as increased customer loyalty, repeated purchases, and/or improved profitability over time. By integrating a survival probability analysis, the organizations may further enhance their understanding of longevity of the campaigns by predicting how long benefits of the campaigns persist, accounting for changes in customer engagement, market conditions, and competitive dynamics.

Despite importance of measuring the success of the campaigns, existing systems have some limitations as explained below. The existing systems often struggle to capture and measure full, long-term impact of the campaigns. The existing systems focus primarily on short-term metrics, such as conversion rates or immediate sales spikes, which fail to account for extended influence of the campaigns on customer behaviour and the long-term value. Furthermore, the existing systems lack sophistication needed to effectively segment customers based on their long-term potential, leading to imprecise predictions and missed opportunities. A challenge faced by the existing systems lies in integrating diverse and complex data sources ranging from transactional and promotional data to behavioural insights and applying advanced analytics to understand how short-term interactions impact a broader journey of a customer. Additionally, the existing systems often lack a capability to adapt to shifting market dynamics or track evolving nature of customer loyalty, making it difficult to adjust strategies in response to changing customer needs and preferences. Thereby, the existing systems may expend a significant amount of time, human resources, and computing resources for measuring the success or impact of the campaigns.

The present disclosure addresses the limitations of the existing systems by providing a comprehensive approach to accurately assess the long-term values of the campaigns by considering survival probabilities and long-term value of the customers. By leveraging advanced statistical and machine-learning based models, and predictive analytics, the present disclosure enables the organizations to optimize their operational strategies, allocate resources more effectively, and make data-driven decisions that enhance long-term customer retention and growth. The optimization not only improves a precision of analysis of the long-term values of the campaigns but also allows the organizations to adjust their approaches based on evolving customer behaviors and market trends, ultimately driving sustainable growth and competitive advantage.

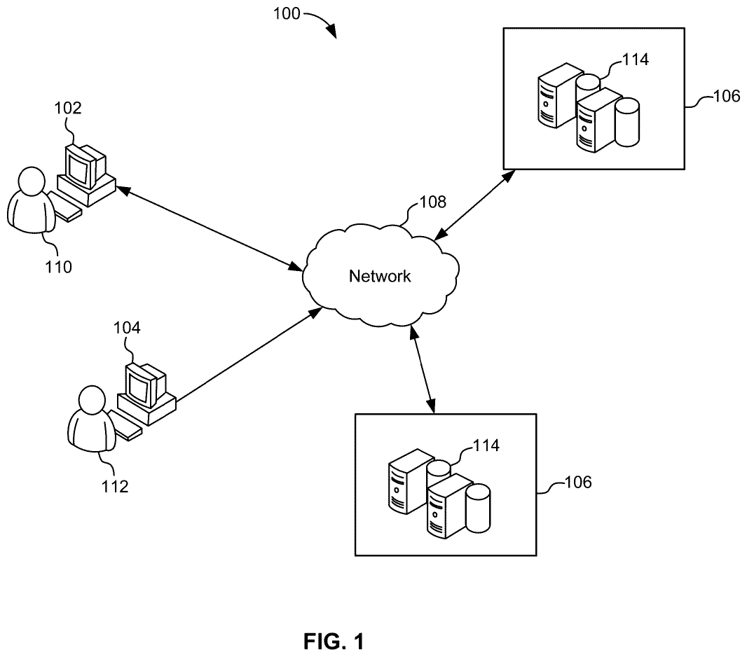

FIG. 1 illustrates an example environment 100 used to execute implementations of the present disclosure. In some examples, the example environment 100 enables estimation of a long-term value as well a short-term value indicating a long-term impact and a short-term impact of a campaign.

As depicted in FIG. 1, the example environment 100 includes computing devices 102 and 104, back-end systems 106, and a network 108. In some examples, the computing devices 102 and 104 are used by a user 110 and a user 112, respectively, to log into and interact with computing platforms (or the back-end systems 106) executing applications according to implementations of the present disclosure. Examples of the user 110 and the user 112 may include, but are not limited to an administrator, a group of people in a team, a campaign manager, a client, an operator, and/or an executive associated with an organization. Examples of the computing devices 102 and 104 may include a server, a notebook, a desktop, a netbook, smartphones, laptops, a tablet, and/or voice-enabled devices. Examples of the organization may be a retail company, a technology company, an E-commerce, an online learning platform, food and beverages company, a healthcare and pharmaceutical company, a travel and hospitality company, and/or the like. It is contemplated that implementations of the present disclosure may be realized with any appropriate type of computing device. In some examples, each of the computing devices 102 and 104 may include a web browser application executed thereon, which may be used to display one or more web pages of a computing platform executing applications. In some examples, each of the computing devices 102 and 104 may display one or more Graphical User Interfaces (GUIs) that enable the user 110 and the user 112, respectively, to interact with the computing platforms.

In some examples, the network 108 may correspond to a communication network. Examples of the network 108 may include, but are not limited to, a Local Area Network (LAN), a Wide Area Network (WAN), the Internet, Wi-Fi, Long Term Evolution (LTE), Worldwide Interoperability for Microwave Access (WiMAX), General Packet Radio Services (GPRS), or a combination thereof. The network 108 communicatively couples or connects the computing devices 102 and 104 with the back-end systems 106. In some examples, the network 108 may be accessed over a wired and/or a wireless communication link. For example, a computing device like smartphone may utilize a cellular network to access the network 108.

In some examples, one or more of the back-end systems 106 may be implemented as an on-premises system that is operated by an organization or a third-party engaged in cross-platform interactions and data management. In some examples, the back-end systems 106 may be implemented as an off-premises system (for example, a cloud or an on-demand system) that is operated by an organization or a third-party on behalf of the organization. In some examples, the back-end systems 106 may be implemented in a cloud environment. For simplicity, the back-end systems 106 depicted in FIG. 1 may be a cloud environment that is intended to represent various forms of servers including a web server, an application server, a proxy server, a network server, a server pool, and/or the like.

In some examples, each of the back-end systems 106 includes survival estimation systems. A survival estimation system 114 of the survival estimation systems may host components of organization systems and associated applications. Also, the survival estimation system 114 receives input from the user 110 and the user 112 (for example, a request to estimate a long-term value and a short-term value of a campaign targeted for multiple customers, a survival probability of customers by an organization, and/or data required for estimating the survival probability) through the respective computing devices 102 and 104 for services being provided by the organization systems and the applications.

In response to the input, the survival estimation system 114 estimates long-term and short-term values of the campaign based on a survival probability of each of multiple customers. In the present disclosure, the campaign may include short-term marketing initiatives. The estimated long-term and short-term values, and/or the survival probability may be further rendered to the user 110 and the user 112 through the respective computing devices 102 and 104. The short-term value refers to an immediate impact of the campaign, such as increased sales, higher conversions, or boosted engagement, within days or months. The long-term value focuses on sustained benefits like customer loyalty, repeat purchases, and long-term brand relationships, contributing to ongoing growth and profitability over time.

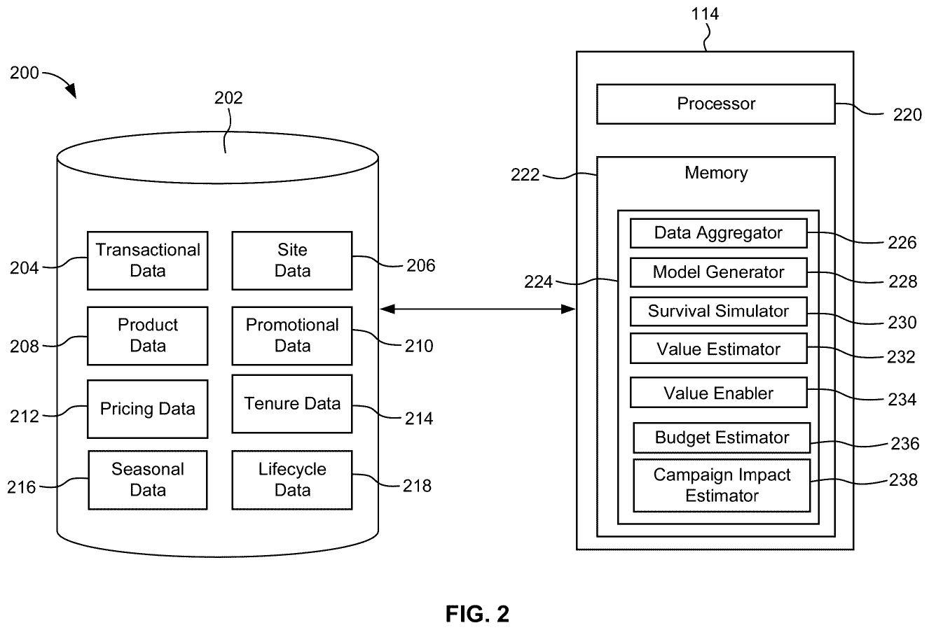

FIG. 2 illustrates a block diagram of a system 200 for estimating a long-term value as well a short-term value indicating a long-term impact and a short-term impact of a campaign, in accordance with implementations of the present disclosure. For example, the campaign may be a marketing campaign, a brand launch campaign, a seasonal campaign, a social media campaign, and/or the like. FIG. 2 is explained in conjunction with FIG. 1. As depicted in FIG. 2, the system 200 includes the survival estimation system 114. In an implementation, the survival estimation system 114 may be communicatively coupled to a database 202. Data included in the database 202 may include data corresponding to various dimensions including, but not limited to, transactional data 204, site data 206, product data 208, promotional data 210, pricing data 212, tenure data 214, seasonal data 216, and/or lifecycle data 218. The data may be associated with various customers and a campaign targeted by a client (e.g., the user 110 and/or the user 112) for the customers. The data related to the various customers may be stored in the database 202 based upon an explicit consent received from each of the customers. The data may be stored and/or deleted per regulations and the consent received from the customers. Therefore, the present disclosure operates only on the data in accordance with the customers' prior consent.

The transactional data 204 include detailed records of customer transactions, such as purchases, order amounts, payment methods, dates, and/or items bought. The transactional data 204 help to track individual customer activities and interactions with the organizations, offering insights into purchasing patterns, preferences, and frequency of buying behavior. For example, the transactional data 204 may be a record showing that a customer purchased a pair of shoes for $50 on a specific date. Further, the site data 206 is data related to interactions of the customers on websites or web applications of digital platforms. The site data 206 include browsing behavior, time spent on pages, click-through rates, search queries, and/or page visits of the customers. The site data 206 help to understand customer interests and engagement on the digital platforms. For example, the site data 206 may include information of web pages that the customers visit most frequently or how long the customers stay on a home webpage. Additionally, in some implementations, the site data 206 may be data related to different outlets, stores, and/or physical sites through which the customers are transacting. In such a case, the site data 206 may also encompass a purchase history and in-store interactions at physical locations. Therefore, the site data 206 helps to understand customer interests and engagement on both digital platforms and physical sites.

Further, the product data 208 may include information related to products that the customers have interacted with or purchased, including product categories, features, prices, ratings, and preferences of the customers for certain products. For example, the product data 208 may be data associated with smartphones or headphones bought frequently by the customers. The promotional data 210 is data related to campaigns, discounts, loyalty programs, or special offers that the customers have interacted with or redeemed. The promotional data 210 include promotional codes, email campaigns, special discounts, and/or seasonal promotions. For example, the promotional data 210 may include information about usage of a 20% off coupon by a customer on a next purchase or responded to a seasonal email promotion.

The pricing data 212 may include information related to prices of products and services at a time of purchase, along with any price changes of the products or the services over time. For example, the pricing data 212 may be information that a customer bought a jacket at a discounted price during a flash sale as compared to a regular price. Additionally, the pricing data 212 may include information related to prices offered by competitors for different products. The tenure data 214 is data regarding a length of time for which the customers have been with the organization or used the products and/or services of the organization. The tenure data 214 include a date on which the customer first engaged with the organization or made a first purchase.

The seasonal data 216 may include customer behavior or product demand patterns based on different seasons, holidays, and/or or special events (e.g., Christmas, back-to-school, summer sales, and/or the like). For example, the seasonal data 216 may include information that the customers buy more outdoor equipment during summer or purchases gifts during winter holiday season. The lifecycle data 218 include different stages in journey of the customer, from acquisition (first contact) to engagement, purchase, and retention, potentially leading to churn. For example, the lifecycle data 218 may include information that the customer in an early stage of a lifecycle may receive welcome offers, while a long-term customer may receive loyalty rewards or be targeted for upsell opportunities.

The survival estimation system 114 includes a processor 220, and a memory 222. In some implementations, the survival estimation system 114 includes more than one processor. The processor 220 may include, for example, microprocessors, microcomputers, microcontrollers, digital signal processors, central processing units, state machines, logic circuits, and/or any devices that manipulate data or signals based on operational instructions. The memory 222 may be a non-volatile memory or a volatile memory. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of the volatile memory may include, but are not limited, a Dynamic Random Access Memory (DRAM), and a Static Random-Access Memory (SRAM).

The memory 222 may be communicatively coupled to the processor 220. The memory 222 stores various instructions, which upon execution by the processor 220, cause the processor 220 to perform various operations described in the present disclosure. The memory 222 includes a survival estimation engine 224. The instructions stored in the memory 222 may define operations of the survival estimation engine 224. The survival estimation engine 224 includes a data aggregator 226, a model generator 228, a survival simulator 230, a value estimator 232, a value enabler 234, a budget estimator 236, and a campaign impact estimator 238.

The data aggregator 226 may aggregate or consolidate the transactional data 204, the site data 206, the product data 208, the promotional data 210, pricing data 212, the tenure data 214, the seasonal data 216, and the lifecycle data 218 (e.g., data that tracks the customers through various stages of their journey, from acquisition to retention). The aggregation of the data provides a comprehensive view of a behavior, preferences, and engagement history of each customer.

In an implementation, the data aggregator 226 may identify churn customers from various customers and expected time for the churn customers to churn from a system, based on the aggregated data. Examples of the system may include but are not limited to an E-commerce platform, a subscription service, an online learning platform, a telecommunication service, and/or the like. The churn customers are customers who are likely to disengage or leave a service from the system. The churn customers are identified based on historical interactions and behaviors, such as a purchase frequency, a product usage, and/or a site engagement. By analyzing the historical interactions and behaviors, the data aggregator 226 may estimate when a customer is most likely to churn, allowing the organization to intervene before the customer churns. To identify the churn customers, the data aggregator 226 may monitor one or more parameters associated with the customers. For example, the data aggregator 226 may monitor a customer's last transaction date in the system and take a buffer of six months to mark a customer's churn date. For example, the one or more parameters may be monitored on a quarterly basis, allowing the organizations to monitor changes in the one or more parameters (e.g., a customer behavior and identify trends, such as an increase in purchases or a decline in engagement). Further, the data aggregator 226 may compute a ratio of increment to decrement based on monitoring of the one or more parameters for each customer. The data aggregator 226 may correlate the one or more parameters and the ratio of increment to decrement corresponding to an observation period to identify the churn customers and the expected time for the churn customers to churn from the system. By correlating the one or more parameters quarter-over-quarter, the organization may gain insight into whether an engagement of the customers is improving or deteriorating, which is vital for predicting future retention or churn.

The data aggregator 226 may use methods like feature engineering to create new variables from the data 204-218 to improve predictive accuracy of churn customers. Further, the data aggregator 226 may use variable reduction methods, such as principal component analysis (PCA), Variance Inflation Factor (VIF), and/or the like, which help to streamline the data to focus on most impactful features, reducing noise and improving efficiency of the survival estimation system 114. The data aggregator 226 may also use methods like sampling and scaling methods to ensure that the churn identification is not biased, particularly when dealing with imbalanced datasets where the majority of customers are retained, and only a small percentage churn. The sampling methods create balanced datasets, while the scaling methods ensure equal contribution of variables. Finally, the data aggregator 226 may segment the customers based on their likelihood of churn.

Once the churn customers are identified and the customers are segmented, the data aggregator 226 may further generate data subsets from the data corresponding to the various dimensions. Each subset corresponds to a specific strategy or intervention. For example, consider a scenario where the customers are segmented into categories as “low-engagement and high value”, and “long term customers with low risk of churn”. In such a case, a first data subset may include data corresponding to “low-engagement and high value” and the strategy corresponding to the first data subset may be “re-engagement campaigns”, “cross-selling or upselling”, “customer success touchpoints”, and/or the like. A second data subset may include data corresponding to “long term customers with low risk of churn”, and the strategy corresponding to the second data subset may be “retention and loyalty enhancement”, engagement through value added content, referral programs, and/or the like.

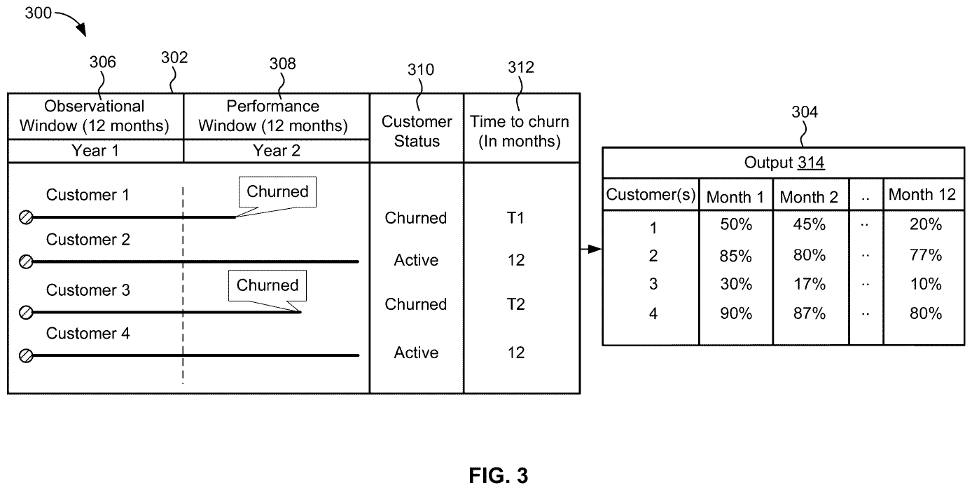

In an implementation, the model generator 228 may generate an ensemble model by selecting a statistical model and/or a machine learning based model for each of the data subsets. The ensemble model may be trained, before deployment, using huge training data. The ensemble model may be trained based on the identified churn customers and expected time for the churn customers, which is further explained in detail in conjunction with FIG. 3. The statistical model may include, but are not limited to, a random forest model, a deep learning survival model, a Cox proportional hazards model, and/or a gradient boost model.

In another implementation, once the ensemble model is deployed, the model generator 228 may utilize the ensemble model to generate a respective score for each data subset. Each data subset may be processed using a corresponding statistical model and/or a machine-learning based model for analyzing a survival aspect of the churn customers. The respective score for each data subset is generated by concurrently processing each data subset using the statistical model and/or machine-learning based model. The survival aspect refers to predicting how long the customer is likely to stay with the system before churning, based on various behavioral and engagement factors. The survival aspect helps to estimate time to churn and assess likelihood of customer retention over time. The each data subset associated with different customers is processed using the statistical model and/or a machine-learning based model. Therefore, for each of the customers, different survival probability scores may be generated.

The survival simulator 230 may receive the respective score generated for the each data subset, for the each customer, from the model generator 228. Further, the survival simulator 230 may compute a survival probability of the each customer. The survival simulator 230 helps to intelligently ensemble results from the statistical model and/or a machine-learning based model, and return a single survival probability for each customer of the customers based on the received respective score. The survival probability refers to likelihood that a customer may continue to engage or remain active with their transaction in the system.

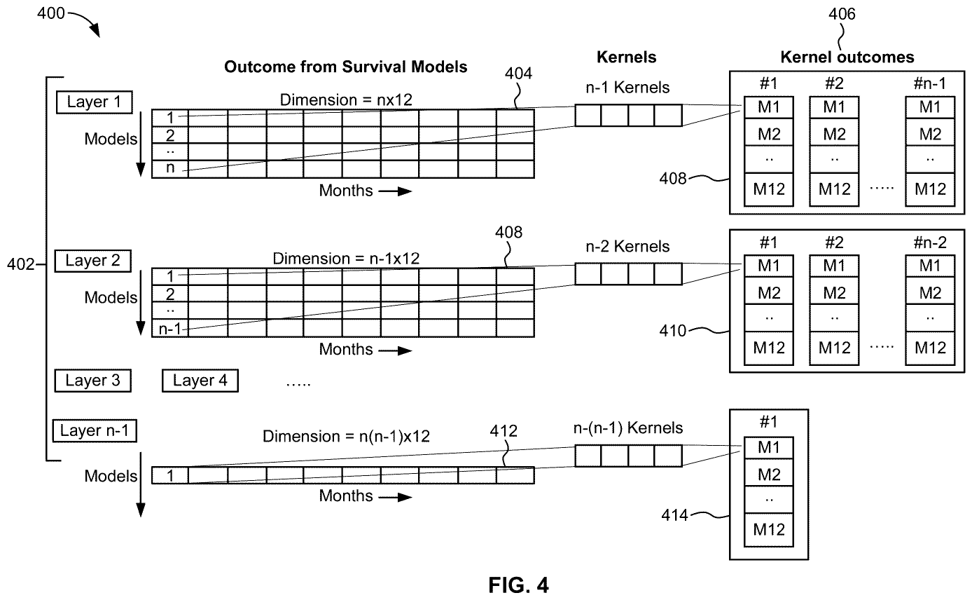

In some examples, to estimate the survival probability, the survival simulator 230 may calculate a weighted average score from the respective score for each data subset. The determination of the weighted average score is explained in detail in conjunction with FIG. 4. The survival simulator 230 operates in multiple layers (e.g., layer 1 to layer (n−1)), where each layer processes an output of a previous layer to generate refined results (e.g., the weighted average score). Based on the weighted average score, the survival simulator 230 may estimate the survival probability of the customer, for example, for a year.

In some other examples, to estimate the survival probability of the customer for two or more years, the value estimator 232 may use an extrapolation function. The data corresponding to the dimensions may be extrapolated to a future value using the selected extrapolation function. As different customers exhibit different behaviors and patterns of engagement with campaigns, the value estimator 232 may use the extrapolation function to adapt the different patterns and behaviors of the customers. The extrapolation function may include a sigmoid function or a negative exponential function. The value estimator 232 may dynamically select one of the sigmoid function or the negative extrapolation function based on engagement patterns of the customers. By selecting the appropriate extrapolation function for each customer, the value estimator 232 improves the accuracy of survival probability estimations, allowing for improved forecasting of customer engagement in the campaign.

For example, some customers may remain loyal for a long time. Such customers show gradual decreases in engagement and in such a case the sigmoid function may be selected. The sigmoid function is given as per equation (1) below:

$$f ( x ) = \frac{1}{1 + {e}^{- k ( x - {x}_{o} )}} \qquad equation ( 1 )$$

Here, “x” represents a time or other factors influencing customer engagement, while “k” and “x₀” are constants determined based on behavior of the customers. Once the sigmoid function is fitted to the data corresponding to the dimensions, the value of “x” may be calculated for a given survival probability “y” as per equation (2) given below:

$$x = {x}_{o} + \frac{1}{k} ln ( \frac{1}{y} - 1 ) \qquad equation ( 2 )$$

Whereas the negative exponential function may be selected for customers that drop off quickly. For example, if engagement of the customer drops sharply and the sigmoid function does not fit the data, the negative exponential function is employed. The negative exponential function is given as per equation (3) given below:

$$y = {e}^{\hat{} ( \overline{t} )} \qquad equation ( 3 )$$

Where “t” represents time, and the exponential decay accurately models rapid decreases in engagement.

Further, the value estimator 232 may determine a respective long-term value (LTV) of each customer of various customers based on the survival probability of the each customer, a historical value, and a discount factor. In an implementation, the value estimator 232 may determine a net present value (NPV) of each of the customers. The NPV may be calculated as per equation (4) given as:

$$NPV = Historical Value \times Survival Probability \times Discount Factor \qquad equation ( 4 )$$

The discount factor is a multiplier that adjusts a future value of cash flows to reflect a time value of money. For example, money received in future may worth less than money received today due to factors such as inflation, risk, and opportunity cost of capital. The discount factor is based on a specified interest rate or discount rate, which may represent factors like inflation rates or required returns. A higher discount factor (indicating a higher interest rate) may reduce the present value of future cash flows.

Further, the historical value refers to a profit margin that a customer has generated (e.g., over a past 1-2 years) for the organization. The historical value may be based on previous purchases, engagement levels, or other metrics that reflect the financial contribution of the customer. The historical value may be influenced by several factors of annual account margin, including product mix, pricing, margins, volume, transaction types, and recency of transactions. For example, the historical value accounts for what the customer has already spent or contributed to the system based on their purchase history. To calculate the historical value, a cost to serve an account associated with a customer may be subtracted, which includes expenses related to such as the support team, account managers, and operational costs tied to servicing the customer. On the other hand, retention costs (e.g., costs associated with keeping the customer loyal, such as retention bonuses and customer retention team costs) may be added to calculate the historical value to reflect total effort the system has invested to maintain the customer relationship. The historical value may be calculated as per equation (5) given below:

$$Historical Value = Annual account margin - Cost to serve + Retention costs \qquad equation ( 5 )$$

By way of an example, consider a scenario, where the historical value that represents the profit margin for a customer is “$100,000” based on past performance of the customer. The survival probability computed for the customer is “0.8”, and the discount factor is “0.9”. In such a case NPV calculated for the customer, using the equation (4), may be “$72, 000” (i.e., $100, 000×0.8×0.9=“$72, 000).

In an implementation, the value estimator 232 may determine a long-term value (LTV) of each of the customers. The LTV may be calculated based on the historical value, the NPV, and customer acquisition costs. The LTV may be calculated as per equation (6) given below:

$$LTV = Historical Value + NPV - customer acquisition costs \qquad equation ( 6 )$$

The customer acquisition costs refer to the expenses involved in acquiring a new customer, including both sales and marketing efforts. Cost of sales encompasses expenses of sales teams, tools, and overheads related to engaging and converting a lead into a paying customer. Additionally, cost of marketing includes costs of marketing teams, campaigns, tools, and overheads needed to attract customers. The customer acquisition costs capture how much the organization is investing in acquiring new customers and helps to determine whether the investments are justified based on the lifetime value the customer may bring.

Further, the value enabler 234 unlocks a potential value of a customer base. The value enabler 234 allows the organization to maximize effectiveness of their resources by ensuring that right customers are identified and treated in the most appropriate way. The value enabler 234 may increase customer lifetime value, enhance customer retention, and improve overall profitability of the organization. The value enabler 234 may classify the customers into one or more groups of customers for the campaign by the client based on at least one of prioritization, and/or treatment differentiation (e.g., differential treatment). The prioritization involves ranking customers based on certain attributes, such as a probability of the customers to chum, past purchase behavior, engagement levels, or lifetime value. For example, by identifying high-priority customers, those who contribute the most or have the highest potential value, the organizations may focus their efforts where the organizations are most likely to see significant returns. Once the customers are prioritized, the one or more groups may be formed. The one or more groups may refer to classification of the customers into segments or clusters based on shared characteristics, behaviors, and/or needs. For example, high-value customers may be grouped into a “VIP” segment, while customers who are at risk of churning may be placed into a “Retention” segment. The differential treatment may involve differentiated treatment strategies. For example, varied levels of service, communication, or incentives may be offered to the customers based on customer segments. All customers are not same; therefore, it is more efficient and effective to tailor the differential treatment strategies according to their value, engagement, and/or churn likelihood. For example, the high-value customers may receive personalized offers, exclusive content, and/or premium customer support, while lower-value customers may get automated messages or general discounts. By offering group-specific differential treatments, the organization may maximize impact of their resources, ensuring that the high-priority customers get attention, while the lower-priority customers are engaged in ways that are more cost-effective.

In an implementation, to classify the customers into one or more groups, the value enabler 234 may compute a customer ability score (CAS) for each customer. The CAS may be computed based on a long-term value, the survival probability of each customer, and a seasonality adjustment factor, as per equation (7), given below:

$$CAS = [ ( 1 - Customer Survival Probability ) \times LTV Score \times Seasonality Adjustment Factor ] \qquad equation ( 7 )$$

Here, the seasonality adjustment factor accounts for fluctuations in customer behavior due to seasonal trends. The customer behavior (e.g., purchases, churn, and/or the like.) may vary depending on time of year. For example, some industries experience higher sales during holiday season or specific quarters. The seasonality adjustment factor may be applied to adjust calculation for expected variations in customer behavior during certain times of the year. For example, if the organization gets a 10% decrease in customer retention during summer months, the seasonality adjustment factor may help to adjust the CAS to account for such trends. Further, the value enabler 234 may segment the customers into the one or more groups of customers for recommending actions to be taken to be taken to increase the long-term value of the campaign. Moreover, each of the one or more groups of customers is assigned with a priority value or a differential treatment.

The budget estimator 236 may identify a budget of the campaign based on the one or more groups of customers, and a plurality of factors. The factors may include expected benefit of the campaign, a margin value to adjust the budget on a predefined margin, a priority of each group of the one or more groups of customers, a size of each of the one or more groups of customers, and a CAS corresponding to each group of the one or more groups of customers. Based on the budget, the organization may decide to invest in the one or more groups of customers or the campaign.

Further, the campaign impact estimator 238 may estimate a long-term value and a short-term value of the campaign based upon the identified budget and the one or more groups of customers. The short-term value may be estimated as per equation (8) to equation (9) given below:

$${Inc}_{spend} = {Test\_spend}_{pos} - ( ( {Test\_spend}_{pre} / {Control\_spend}_{pre} ) * {Control\_spend}_{pos} ) \qquad equation ( 8 )$$

$$Where :$$

$${Test\_spend}_{pos} = {\sum }_{{pos}_{i} = 1}^{n} {Spend}_{{pos}_{i}} \qquad equation ( 8 a )$$

$${Test\_spend}_{pre} = {\sum }_{{pre}_{i} = 1}^{n} {Spend}_{{pre}_{i}} \qquad equation ( 8 b )$$

$${Control}_{{spend}_{pos}} = {\sum }_{{pos}_{j} = 1}^{m} {Spend}_{{pos}_{j}} \qquad equation ( 8 c )$$

$${Control\_spend}_{pre} = {\sum }_{{pre}_{j} = 1}^{m} {Spend}_{{pre}_{j}} \qquad equation ( 8 d )$$

$$Further , {Short\_term}_{uplift} = {Margin}_{uplift} * {Campaign}_{cost} \qquad equation ( 9 )$$

$$Where :$$

$${Margin}_{uplift} = {Inc}_{spend} * {Margin}_{per \_ cust} \qquad equation ( 9 a )$$

$${Campaign}_{cost} = {Offer}_{cost} + {Setup}_{cost} \qquad equation ( 9 b )$$

Here, “Inc_{spend}” denotes incremental spend of the customers when test and control group of the customers are compared within pre-period and post-period of the campaign. “Test_spendₚᵣₑ” is spend for test customers in pre-period of the campaign. “Test_spendₚₒₛ” is spend for the test customers in post-period of the campaign. “Control_spendₚᵣₑ” and “Control_spendₚₒₛ” are spend for control customers in pre-period and post-period of the campaign, respectively.

The long-term value may be calculated as per equation (10), given below:

$${Inc}_{NPV} = {Test\_NPV}_{pos} - ( ( {Test\_NPV}_{pre} / {Control\_NPV}_{pre} ) * {Control\_NPV}_{pos} ) \qquad equation ( 10 )$$

$$Where :$$

$${Test\_NPV}_{pos} = {\sum }_{{pos}_{i} = 1}^{n} {NPV}_{{pos}_{i}} \qquad equation ( 10 a )$$

$${Test\_NPV}_{pre} = {\sum }_{{pre}_{i} = 1}^{n} {NPV}_{{pre}_{i}} \qquad equation ( 10 b )$$

$${Control\_NPV}_{pos} = {\sum }_{{pos}_{j} = 1}^{m} {NPV}_{{pos}_{j}} \qquad equation ( 10 c )$$

$${Control\_NPV}_{pre} = {\sum }_{{pre}_{j} = 1}^{m} {NPV}_{{pre}_{j}} \qquad equation ( 10 d )$$

Here, “Inc_{NPV}” is incremental NPV of the campaign when the test and control group of customers are compared within the pre-period and the post-period of the campaign. Further, “Test_NPVₚᵣₑ” and “Test_NPVₚₒₛ” are NPV of the test customers in the pre-period and the post period of the campaign, respectively. “Control_NPVₚᵣₑ” and “Control_NPVₚᵣₑ” are NPV of the control customers in the pre-period and the post-period of the campaign, respectively.

FIG. 3 illustrates an example scenario 300 of training an ensemble model for computing survival probabilities of the customers, in accordance with implementations of the present disclosure. FIG. 3 is explained in conjunction with FIGS. 1-2.

The example scenario 300 includes a first table 302 and a second table 304 (e.g., an output table). The first table 302 provides a framework for observing behavior customers (e.g., customer 1, customer 2, customer 3, and customer 4) and defining important metrics related to churn. The first table 302 includes an observation window 306 which is a 12-month period during which the ensemble model may observe and gather independent variables that help predict future behavior of the customers (e.g., customer 1, customer 2, customer 3, and customer 4). The independent variables from the observation window 306 may be used as features or input data to the ensemble model. For example, the independent variables may include purchase frequency, transaction volume, or engagement level, which reflect a past behavior of the customers (e.g., customer 1, customer 2, customer 3, and customer 4). As illustrated in FIG. 3, a first year (referred to as “Year 1”) is used to understand a recent behavior of the customers (e.g., customer 1, customer 2, customer 3, and customer 4). Further, the second table 304 includes a performance window 308 which is a 12-month period (referred to as “Year 2”) used to analyze predictions of the ensemble model, which in this case is determining if the customers (e.g., customer 1, customer 2, customer 3, and customer 4) have churned or remain active. For example, customer 1 and customer 3 are churned. During the performance window 308, dependent variables are measured, including a customer status 310 (whether a customer is “active” or “churned”) and a time to churn 312 (which is a length of time in months taken for the customer to churn). The dependent variables e.g., a customer status and time to churn) may be used as labels or targets for the ensemble model to learn during training. For example, the customer status 310 corresponding to the customer 1 and customer 3 is “churned”, and the customer 2 and customer 4 is “active”. Further, for example, the time to churn 312 corresponding to the customer 1 and customer 3 is “T1” and “T2” respectively, and the customer 2 and customer 4 is “12 months”.

The customer status 310 indicates whether the customer has ceased engaging with the service, typically defined as having no transactions for a given number of months (referred to as “x months” (e.g., 3 months, 5 months, 6 months, 12 months, and/or the like) in a performance period). If the customer remains inactive for a period specified, that customer may be considered to have churned. A churn duration (i.e., the time to churn 312) is defined as number of months the customer has been active before the customers has churned. For example, the customer may have been using a service for 10 months before stopping activity (i.e., churning). The first table 302 captures historical customer data (e.g., the observation window 306) and uses the observation window 306 to forecast customer behavior during the performance window 308, considering a time until churn and the status of the customer.

Once the ensemble model is trained using data from the first table 302, the second table 304 illustrates predictions generated using the ensemble model for each customer regarding survival probabilities of the customers. The second table 304 provides an output 314 computed using the ensemble model for each of the customers (e.g., customer 1, customer 2, customer 3, and customer 4). Each row in the second table 304 corresponds to a different customer, and each column represents a survival probability of the customers e.g., customer 1, customer 2, customer 3, and customer 4) month by month across a given performance period of 12 months. For example, for month 1, the survival probability of corresponding to the customer 1, customer 2, customer 3, and customer 4 is “50%”, “85%”, “30%”, and “90%”, respectively. The ensemble model provides a dynamic, time-sensitive estimate of customer retention, making it a crucial for the organization that needs to understand not only whether a customer may churn, but also when the customer may churn. The second table 304 is structured to reflect how survival probabilities evolve over time for different customers, allowing the organization to take proactive steps to retain high-risk customers before the customers churn form the system.

FIG. 4 illustrates an example scenario 400 of generating a weighted average score from respective scores for the data subsets using the survival simulator 230, in accordance with implementations of the present disclosure. FIG. 4 is explained in conjunction with FIGS. 1-3.

The survival simulator 230 may employ multiple layers to calculate the weighted average score and the survival probability of each customer. As illustrated in FIG. 4, the survival simulator 230 may include “n−1” number of layers (e.g., a layer 1 to a layer (n−1)) 402. Further, a layer 1 includes outcomes 404 from “n” number of statistical models for each customer (i.e., a metric of dimension “n*12”, where 12 is number of months of survival probability prediction). Further, in each layer, kernels are used to generate kernel outcomes 406. Each layer utilizes a kernel outcome of previous layer to generate a kernel outcome of the each layer. For example, a kernel outcome 408 generated in the layer 1 may be utilized by in a layer 2 for generating a kernel outcome 410. Similarly, a kernel outcome 412 generated in a layer “n−2” (not depicted in FIG. 4) may be utilized in the layer “n−1” to generate a kernel outcome 414. The layer 2 includes the kernel outcome 408 corresponding to “n−1” number of statistical models (i.e., a metric of dimension “n−1×12”), and the layer “n−1” includes the kernel outcome 412 corresponding to one statistical model (i.e., a metric of dimension “n(n−1)×12”). Generation of the kernel outcomes 406 is explained in detail further in the following paragraphs.

For example, in the “layer 1”, the outcomes 404 (e.g., a respective score for each data subset) of the “n” number of statistical models may be aggregated, over a 12-month period. Each statistical model may have produced outcomes or predictions for each month, such as the respective score. The outcomes 404 or predictions are organized in a form of matrix with “n” rows (representing the statistical models) and 12 columns (each representing a month). Further, the survival simulator 230 may use “n−1” number of kernels (with n dimension). The “n−1” kernels are used to combine the respective score in a way that minimizes redundancy and avoids overfitting. A number of kernels used in each layer is less than a number of models considered in each layer. For example, in the layer 2, the kernel outcome 408 is utilized which is corresponding to “n−1” statistical models, and the kernels used in the layer 2 are “n−2” which is less than “n−1”. For each kernel, a weight is assigned to each statistical model based on a performance, which is measured by a metric of the statistical model such as an accuracy, a precision, and/or some other relevant indicators. Weights may be normalized so that total weight of the statistical models within a kernel sum to “1”. Specifically, if performance of an “i^{th}” statistical model is denoted as “ai”, a corresponding weight “Kᵢ” for the kernel is calculated as per equation (11) given below:

$${}_{Ki} = \frac{{a}_{i}}{{\sum }_{i = 1}^{i = n} {a}_{i}} \qquad equation ( 11 )$$

Equation (11) is used to generate the kernel outcomes 406 as illustrated in FIG. 4. With regards to the layer 1, the equation (11) ensures that the “n” statistical models with improved performance may contribute more to a final prediction (e.g., a kernel outcome 408) of the “n−1” kernels. The kernel outcome 408 is then a weighted average of the respective of the statistical models “n”, with contribution of each statistical model proportional to its normalized weight. Each layer processes an output of a previous layer to each subsequent layer to generate refined results (e.g., the weighted average score). For example, the kernel outcome 408 of the layer 1 is processed to the layer 2, and the kernel outcome 412 of the layer “n−2” may be processed to the layer “n−1”. Similarly, a weighted average score and a kernel outcome (for example, the kernel outcome 410 in layer 2, and the kernel outcome 412 in layer “n−1”) may be generated in the next layers from the layer 2 to layer “n−1”, using the equation (11).

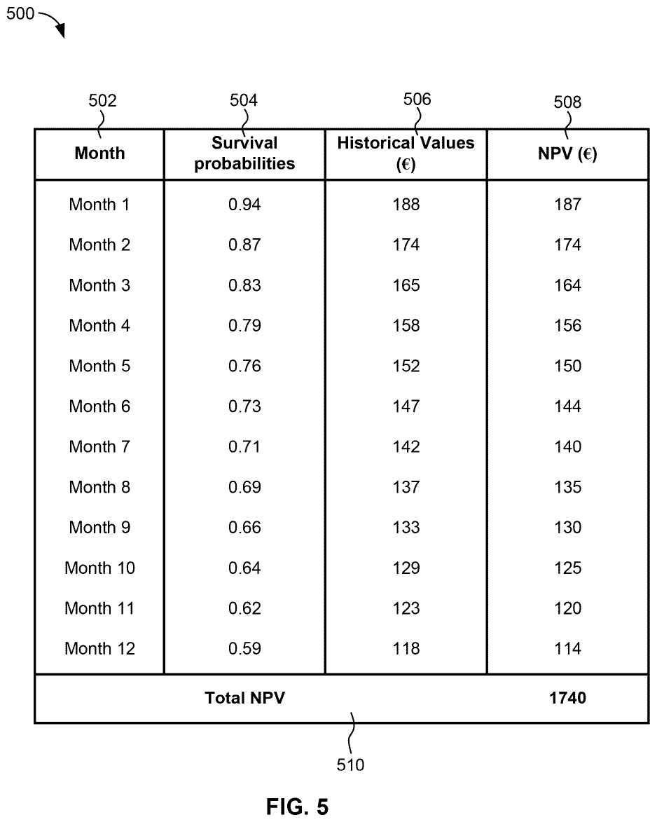

FIG. 5 illustrates an example table 500 representing determination of a total net present (NPV) for one customer for a predefined time period, in accordance with implementations of the present disclosure. FIG. 5 is explained in conjunction with FIGS. 1-4.

The table 500 includes four columns including a month(s) 502, survival probabilities 504, historical value(s) 506, and NPVs 508. Further, the table 500 includes 12 rows corresponding to 12 months (i.e., the predefined period is 12-months, and each row corresponds to a month). For example, the survival probabilities) 504 corresponding to the 1 to 12 months are 0.94, 0.87, 0.83 . . . 0.59, respectively. The historical value(s) 506 corresponding to 1 to 12 months are 118, 174, 165, . . . , 118, respectively. Further, the NPVs 508 may be calculated using the equation (4) given in FIG. 2. For example, an NPV of the NPVs 508 for the customer for the first month may be 187 (e.g., 0.94×188×1.05 (discount factor)=187). Similarly, the NPVs 508 may be calculated for other months from month 2 to 12 as 174, 164, . . . , 114, respectively. Further, a total NPV 510 of the customer as 1750 is calculated by adding the NPVs 508 of 12 months, which represents a combined present value of all expected contributions from the customer over the 12-month period. The total NPV 510 provides a holistic view of expected worth of the customer over a given timeframe, aiding in decision-making regarding customer retention and investment strategies.

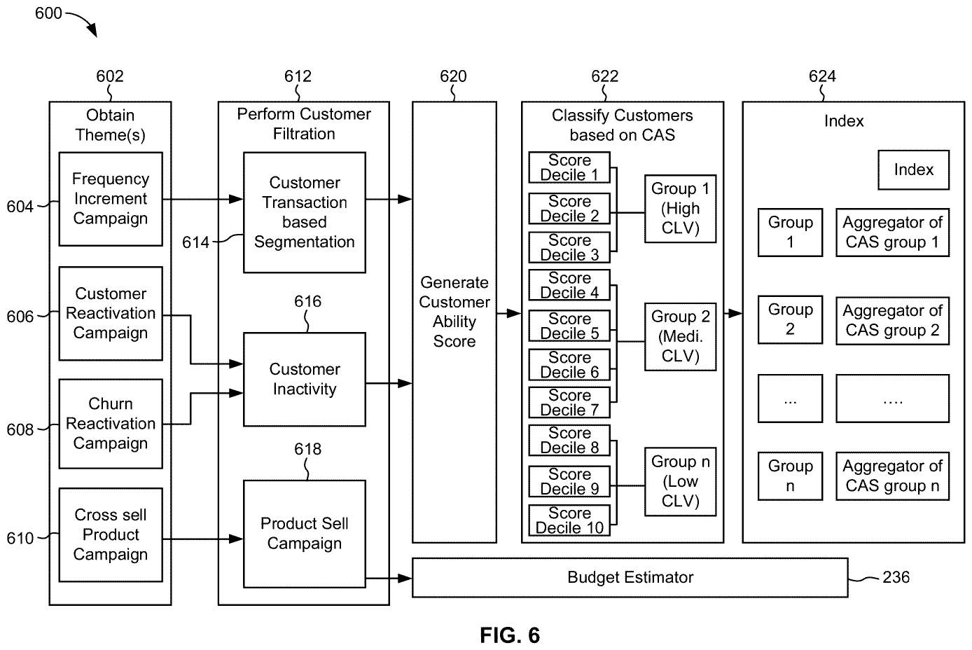

FIG. 6 illustrates an example process flow 600 of classifying customers into one or more groups of customers based on prioritization, in accordance with implementations of the present disclosure. FIG. 6 is explained in conjunction with FIGS. 1-5.

The process flow 600 includes obtaining 602 various themes including a frequency increment campaign 604, a customer reactivation campaign 606, a churn reactivation campaign 608, and a cross-sell product campaign 610. The frequency increment campaign 604 may be a campaign that encourages customers to increase frequency of their purchases or interactions with the organization. The frequency increment campaign 604 may target customers who are already active but need an effort to engage more frequently. The customer reactivation campaign 606 may target customers who have become inactive, with the goal of re-engaging the inactive customers. The customer reactivation campaign 606 may focus on customers who have not made a purchase or interacted with the organization for a specific period of time, for example, such as 3, 6, or 12 months. The churn reactivation campaign 608 may be similar to the customer reactivation campaign 606, specifically targets customers who are at a higher risk of churn or have already churned. The objective of the churn reactivation campaign 608 may be to win the customers back before they fully disengage or to reintroduce them to the organization after the customers have left. The cross-sell product campaign 610 focuses on cross-selling complementary products to existing customers. The cross-sell product campaign 610 may increase an average order value (AOV) or customer lifetime value (CLV) by promoting products that enhance or complement previous purchases.

Further, the process flow 600 includes performing 612 customers filtration based on the themes. The customer filtration is a process of narrowing down customer base based on specific criteria that align with the themes of each campaign. For example, the customer filtration may be performed 612 based on methods such as a customer transaction-based segmentation 614, a customer inactivity 616 (e.g., customers who have been inactive for 2 months, 6 months, or another predefined period may be targeted for re-engagement campaigns), and a product sell campaign 618. In the customer transaction-based segmentation 614, customers are categorized based on a number of transactions the customers have made. For example, customers with more than 10 transactions may be considered highly engaged, customers with between 4 and 10 transactions may be considered as moderately engaged, and customers with fewer than 4 transactions are considered as more passive or having recently started interacting with the organization. The product sell campaign 618 may focus on customers who may be interested in upselling or purchasing complementary products. For example, if a customer has previously purchased a certain product, the customer may be targeted with a campaign for a related product or an upgrade.

The process flow 600 includes generating 620 a customer ability score (CAS) for the filtered customers using the equation (7). The generation of CAS is already explained in detail in FIG. 2, therefore repeated description is omitted herein for sake of brevity. The process flow 600 further includes classifying 622 the customers into one or more groups of customers based on the corresponding CAS. For example, score deciles 1 to 3 are classified into group 1, score deciles 4 to 7 are classified into group 2, score deciles 8-10 are classified into group n. Customers of group 1 are top customers with the highest CAS, indicating high customer lifetime value (CLV). The top customers are more loyal and likely to respond positively to the campaign which makes the customers of group 1 ideal targets for personalized, high-impact marketing efforts. Further, customers of group 2 have a moderate CAS. The customers of group 2 may be engaged, but not as loyal or high-value as top deciles. Customers of group n have the lowest CAS, indicating the customers of group n are either less engaged, have a higher likelihood of churn, or have not yet demonstrated strong buying behavior or loyalty.

Further, the process flow 600 includes indexing 624 the classified one or more groups of customers (e.g., group 1 to group n) to prioritize marketing efforts. For example, the high CLV group (deciles 1-3) may be prioritized for exclusive offers or premium campaigns, while the medium and low CLV groups may receive more generic or cost-effective marketing initiatives. Further, the budget estimator 236 (shown in FIG. 2) may use the classifications to determine how to allocate resources for each campaign. The budget estimator 236 considers not only number of customers in each group but also factors like customer potential, projected return on investment, marketing budget available, and the like.

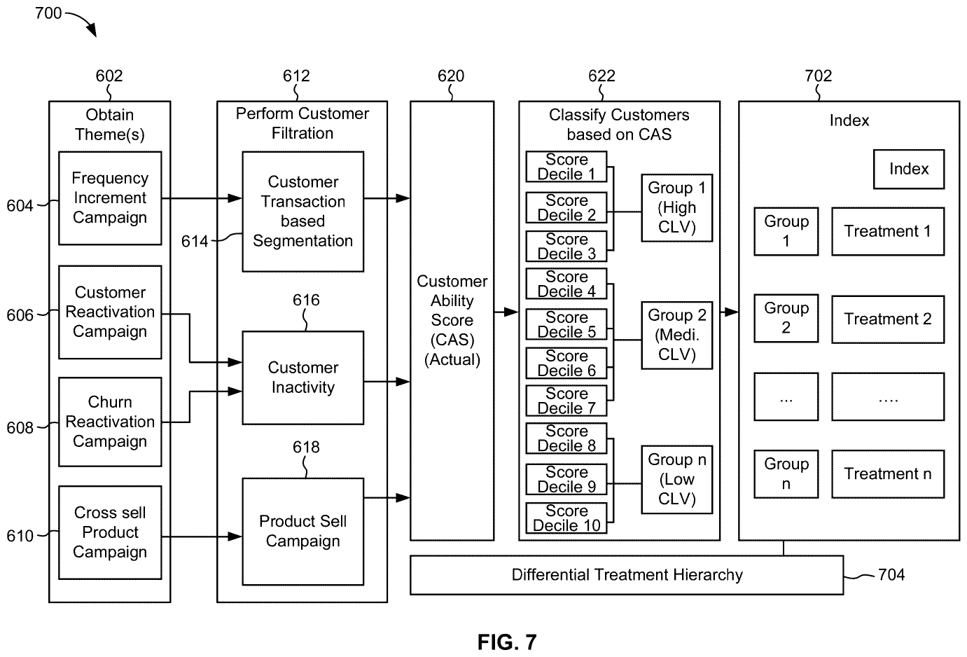

FIG. 7 illustrates an example process flow 700 of classifying customers into one or more groups of customers based on differential treatment, in accordance with implementations of the present disclosure. FIG. 7 is explained in conjunction with FIGS. 1-6.

The process flow 700 is same as the process flow 600 (described in FIG. 6) till the generation of group 1, group 2, and group n. Further, the process flow 700 includes indexing 702 the classified one or more groups of customers (e.g., group 1 to group n) based on differential treatment hierarchy 704. The indexing 702 refers to assigning a level of treatment to each group based on the classification, ensuring that marketing efforts and resources are allocated in a way that reflects their value and potential. The term differential treatment hierarchy 704 refers to an approach where each group is treated differently based on a value, behavior, and likelihood of each group, to respond to marketing interventions. For example, the group 1 may receive more personalized, high-touch marketing efforts such as exclusive offers, premium product recommendations, or loyalty incentives, as the group 1 represents the most valuable customers. The group 2 may be targeted with general promotional campaigns or special offers that aim to increase engagement or encourage higher spending. The group 2 may need more nurturing to increase their value over time. The indexing 702 ensures that customers are given differentiated treatment based on potential of the customers to generate value, thus optimizing marketing efforts and improving the efficiency of campaign budgets.

For example, the differential treatment hierarchy 704 starts with a baseline level of treatment (e.g., a treatment 1), which may be a standard level of engagement or marketing effort applied to a least valuable or least engaged customer group. For subsequent groups, the baseline level of treatment may be adjusted by a differential proportion, reducing a level of marketing effort or attention in a gradual manner as customer value decreases, thereby creating a subsequent treatment. For example, the subsequent treatment that is a treatment 2 may be determined as (1−differential proportion) multiplied by the treatment 1, meaning that the subsequent treatment is slightly reduced as compared to the baseline level of treatment. Similarly, a treatment ‘n’ for any subsequent group may be determined as (1−differential proportion) multiplied by treatment (n−1), creating a cascading effect where each successive group receives progressively lower levels of marketing effort or engagement.

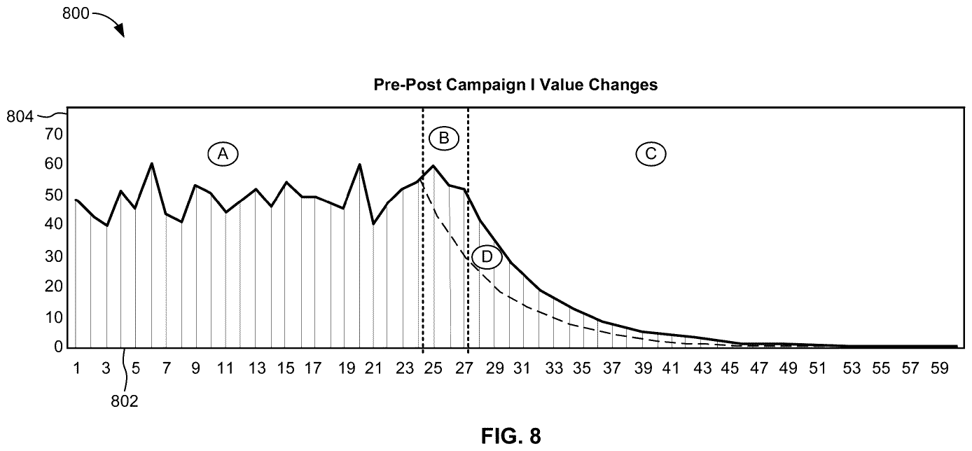

FIG. 8 illustrates an example graph 800 representing value change of customers over time during a campaign, in accordance with implementations of the present disclosure. FIG. 8 is explained in conjunction with FIGS. 1-7.

The graph 800 illustrates how a customer value changes over time before, during, and after the campaign. On the X-axis 802, time is represented in months (e.g., 1, 3, 5, 7, etc.), while the Y-axis 804 shows customer value, such as revenue or customer lifetime value, with increments like 0, 10, 20, and so on. Before the campaign (i.e., a pre-campaign period), the customer value may decline gradually due to churn or decreased engagement.

In the graph 800, from months 1 to 24, an area “A” represents historical spend of the customer, showing their behavior prior to the campaign. An area “B” represents a period during which the campaign is executed for the customer. The area “B” represents a campaign initiative, which leads to a temporary increase in customer activity and value. An area “C” represents a post-campaign decline, where every customer is expected to decline at different rates based on the chum possibility from their similar cohort. An area marked “D” represents how the campaign initiative positively influenced customer behavior, helping to slow down the rate of decline in customer value post-campaign. In other words, a dotted line in the graph 800 indicates a survival probability of the customer if the customer has not been influenced by the campaign. The dotted line continues from month 24 onwards, showing the expected trend based on historical behavior. However, since the customer is positively influenced by the campaign and increased transactions or spend during the area “B”, the survival probability of the customer follows a bold line, which extends from month 27 onwards in the area “C”. The bold line shows an improved survival probability of the customer as a result of influence of the campaign.

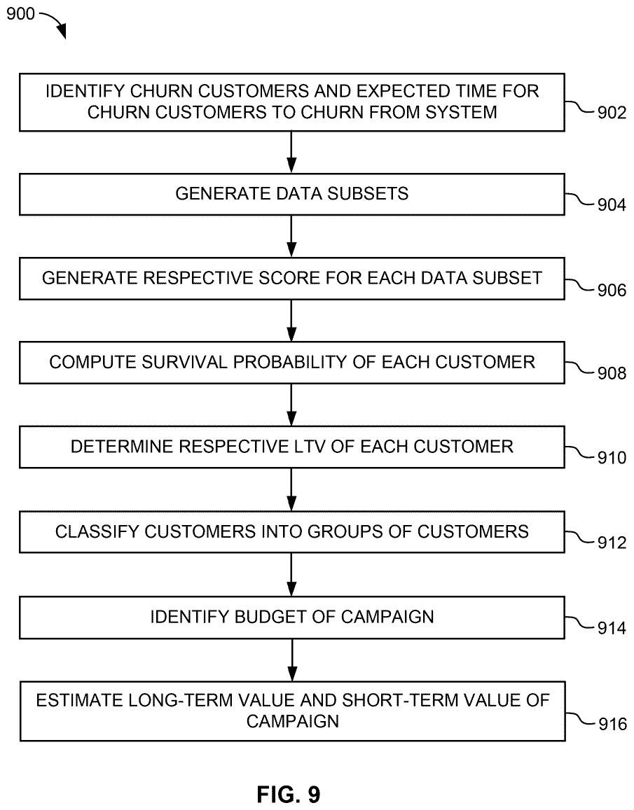

FIG. 9 illustrates a flow diagram that presents an example method 900 for estimating the long-term and short-term values of the campaign, in accordance with implementations of the present disclosure. In some implementations, the process flow may be implemented within the survival estimation system 114. FIG. 9 is explained in conjunction with FIGS. 1-8.

The method 900 includes identifying 902 churn customers from various customers and expected time for the churn customers to churn from a system, based on data corresponding to various dimensions. The dimensions may include one or more of transactional data, promotional data, pricing data; tenure data; site data, product data, seasonal data, and lifecycle data of a customer. To identify the churn customers and the expected time for the churn customers, in an implementation, one or more parameters associated each customer of the various customers may be monitored. Further, a ratio of increment to decrement may be computed based on the monitoring of the one or more parameters associated with each customer across a quarter. The one or more parameters for the each customer and the ratio of increment to decrement corresponding to an observation period may be corelated to identify the churn customers and the expected time for the churn customers to churn from the system. The method 900 further includes generating 904 data subsets from the data corresponding to the various dimensions. The identification 902 and the generation 904 are already explained in detail in conjunction with the data aggregator 226 in FIG. 2.

The method 900 further includes generating 906 a respective score for each data subset of the data subsets by processing each data subset using a statistical model/or and machine-learning based model for analyzing survival aspect of each customer of the various customers. The statistical model and/or the machine-learning model may be trained based on the identified churn customers and expected time for the churn customers. The statistical model or the machine-learning model may include at least one of a random forest model, a deep learning survival model, a cox proportional hazardous model, or a gradient boost model. The respective score for each data subset of the data subsets may be generated by concurrently processing each data subset using the statistical model or the machine-learning model. The generation 906 of the respective score has already been explained in detail in conjunction with the model generator 228 in FIG. 2.

The method 900 includes computing 908 a survival probability of each customer of the various customers. The survival probability may be computed based upon a weighted average score. The weighted average score may be generated from the respective score for each data subset, which has been explained in detail in conjunction with FIG. 4. The computation 908 is already explained in detail in conjunction with survival simulator 230 in FIG. 2.

The method 900 includes determining 910 a respective long-term value (LTV) of each customer of the plurality of customers based on the survival probability of the each customer, a historical value, and a discount factor. In some implementations, an extrapolation function may be selected based upon the survival probability of each customer of the plurality of customers. The extrapolation function includes one of a sigmoid function or a negative exponential function. Further, the data corresponding to the plurality of dimensions may be extrapolated to a future value using the selected extrapolation function. The determination 910 of value is already explained in detail in conjunction with value estimator 232 in FIG. 2, and FIG. 5.

The method 900 further includes classifying 912, based on the LTV of each customer, customers into one or more groups of customers for a campaign by a client. Each of the one or more groups of customers is related to a theme. A CAS may be computed based upon the respective LTV of the each customer of the plurality of customers, the survival probability of each customer of the plurality of customers, and a seasonality adjustment factor. Further, the customers may be segmented into the one or more groups of customers, based on the CAS for each customer of the customers, for recommending actions to be taken to be taken to increase a long-term value of the campaign. Each of the one or more groups of customers may be assigned with a priority value or a differential treatment. The classification 912 has already been explained in detail in conjunction with the value enabler 234 in FIG. 2, FIG. 6, and FIG. 7.

The method 900 includes identifying 914 a budget of the campaign, based on the one or more groups of customers, and various factors. The factors may include expected benefit of the campaign, a margin value to adjust the budget on a predefined margin, a priority of each group of the one or more groups of customers, a size of each of the one or more groups of customers, and a CAS corresponding to each group of the one or more groups of customers. The identification of the budget is explained in detail in conjunction with the budget estimator 236 in FIG. 2.

The method 900 includes estimating 916, based upon the identified budget and the one or more groups of customers, the long-term value and a short-term value of the campaign, which has been explained in detail in FIG. 2 and FIGS. 6-8.

Implementations of the present disclosure provide technical solutions to multiple technical problems that arise in estimating a long-term value as well a short-term value indicating a long-term impact and a short-term impact of a campaign. Implementations of the present disclosure provide an ability to integrate multiple statistical models to generate an ensemble model to predict customer behavior and long-term value. By using parallel and multi-processing approaches to combine outputs of the multiple statistical models such as random forests, deep learning survival models, and gradient boosting models, the survival estimation system 114 may understand complex customer dynamics and churn behavior. The ensemble model ensures that the most accurate predictions are made by leveraging the strengths of each statistical model, allowing for a more precise estimate of the long-term value of the campaign with improved computational efficiency. The integration of multiple statistical models enhances reliability and robustness of survival predictions, providing organizations more confidence in their strategic planning.

Implementations of the present disclosure further provides the value estimator 232 that uses extrapolation function that enables long-term forecasting from short-term historical data. Traditional models typically rely on long-term data to predict future trends, which may not always be available. The extrapolation function fills that gap by leveraging short-term customer behavior and adjusting the extrapolation function to predict future actions, providing valuable insights into customer retention and value over extended periods. The ability to predict long-term behavior from limited data significantly expands a horizon for long-term strategic planning, allowing organizations to make well-informed decisions even with sparse historical information.

Further, the survival estimation system 114 considers prioritization and differential treatment for classifying the customers into groups. By calculating a customer ability score (CAS), the disclosure classifies customers into different groups based on their potential for long-term value. This type of classification enables the organizations to tailor their campaigns with a focus on high-value customers, increasing likelihood of maximizing returns while minimizing unnecessary spend on low-value or low-potential customers.

Moreover, the implementations of the present disclosure provide an ability to estimate the campaign budget based on the prioritized groups ensures a more efficient allocation of resources, improving the overall return on investment (ROI) for operational efforts. By aligning campaign strategies with customer value, the organizations may execute more targeted, data-driven campaigns that result in higher effectiveness. Further, the implementations of the present disclosure provide an ability to quantify the long-term incremental value post-campaign. By measuring not just the immediate, short-term impact of campaigns, but also their long-term effects, the organizations may gain deeper insights into the effectiveness of the campaigns. The survival estimation system 114 uses survival probabilities and seasonality adjustment factors in forecasting future value which allows the organizations to track sustained impact of their efforts and refine future campaigns accordingly. Further, a holistic approach to campaign evaluation ensures that the organizations are not only optimizing short-term revenue but also making strategic investments in long-term customer relationships, which ultimately drives sustained growth and profitability.

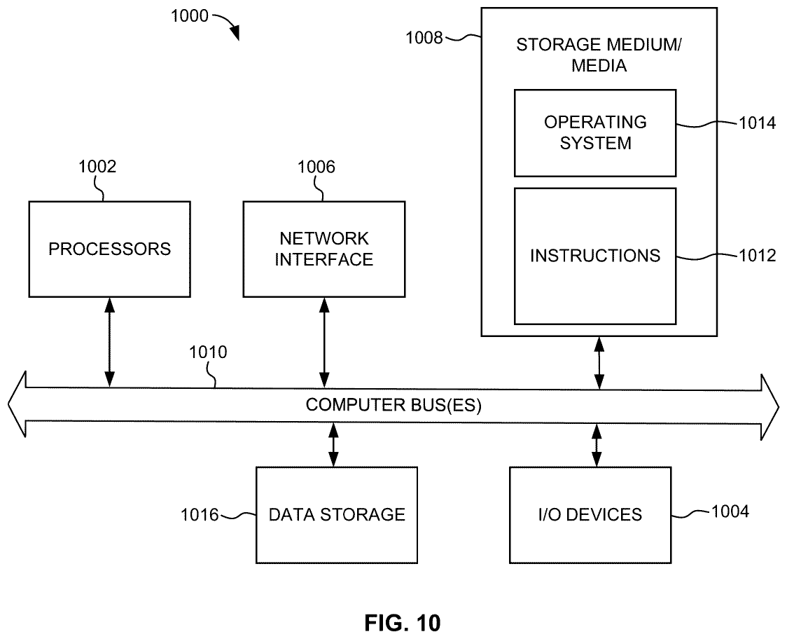

FIG. 10 illustrates a computer system 1000 that may be used to implement the survival estimation system 114. More particularly, computing machines such as desktops, laptops, smartphones, tablets, and/or wearable electronic devices which may be used for estimating short-term and long-term values of the campaign and may have the structure of the computer system 1000. The computer system 1000 may include additional components not shown and that some of the process components described may be removed and/or modified. In another example, a computer system 1000 may be deployed on external-cloud platforms such as cloud, internal corporate cloud computing clusters, organizational computing resources, and/or the like.

The computer system 1000 includes processor(s) 1002, such as a central processing unit, a controller, an application specific integrated circuit (ASIC), or another type of processing circuit, input/output devices (I/O) 1004, such as a display, a mouse, a keyboard, etc., a network interface 1006, such as a Local Area Network (LAN) interface, a wireless 802.11x interface, a 3G, 4G, 5G, or 6G mobile WAN or a WiMax WAN, and a computer-readable medium 1008. Each of these components may be operatively coupled with each other via one or more computer bus(es) 1010. The computer-readable medium 1008 may be any suitable medium that participates in providing instructions to the processor(s) 1002 for execution. For example, the computer-readable medium 1008 may be non-transitory or non-volatile medium, such as a magnetic disk or solid-state non-volatile memory or volatile medium such as RAM. The instructions or modules stored on the computer-readable medium 1008 may include machine-readable or machine-executable instructions or code 1012 executed by the processor(s) 1002 that cause the processor(s) 1002 to perform the methods and functions of the survival estimation system 114.

The survival estimation system 114 may be implemented as software stored on a non-transitory computer-readable medium and executed by the processors 1002. For example, the computer-readable medium 1008 may store an operating system 1014, such as MAC OS, MS WINDOWS, UNIX, or LINUX, and code 1012 for the survival estimation system 114. The operating system 1014 may be multi-user, multiprocessing, multitasking, multithreading, real-time, and the like. For example, during runtime, the operating system 1014 and the code for the survival estimation system 114 are executed by the processor(s) 1002.

The computer system 1000 may include a data storage 1016, which may include non-volatile data storage. The data storage 1016 stores any data used or generated by the survival estimation system 114.

The network interface 1006 connects the computer system 1000 to external systems for example, via a LAN. Also, the network interface 1006 may connect the computer system 1000 to the Internet. For example, the computer system 1000 may connect to web browsers and other external applications and systems via the network interface 1006.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (e.g., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
identifying, based on data corresponding to a plurality of dimensions, churn customers from a plurality of customers and expected time for the churn customers to churn from a system;
generating a plurality of data subsets from the data corresponding to the plurality of dimensions;
generating a respective score for each data subset of the plurality of data subsets by processing the each data subset using at least one statistical model or machine-learning based model for analyzing survival aspect of each customer of the plurality of customers, wherein the at least one statistical model or machine-learning based model is trained based on the identified churn customers and expected time for the churn customers;
computing a survival probability of the each customer of the plurality of customers, based upon a weighted average score, wherein the weighted average score is generated from the respective score for the each data subset;
determining a respective long-term value (LTV) of the each customer of the plurality of customers based on the survival probability of the each customer, a historical value, and a discount factor;
classifying, based on the respective LTV of the each customer, the plurality of customers into one or more groups of customers for a campaign by a client, wherein each of the one or more groups of customers is related to a theme;
identifying a budget of the campaign, based on the one or more groups of customers, and a plurality of factors; and
estimating, based upon the identified budget and the one or more groups of customers, a long-term value and a short-term value of the campaign.

2. The computer-implemented method of claim 1, wherein identifying the churn customers and the expected time for the churn customers comprises:
monitoring one or more parameters associated with the each customer of the plurality of customers;
computing a ratio of increment to decrement based on the monitoring of the one or more parameters for the each customer; and
correlating the one or more parameters and the ratio of increment to decrement corresponding to an observation period to identify the churn customers and the expected time for the churn customers to churn from the system.

3. The computer-implemented method of claim 1, wherein the at least one statistical model or machine-learning based model includes a random forest model, a deep learning survival model, a cox proportional hazardous model, or a gradient boost model.

4. The computer-implemented method of claim 1, wherein the data corresponding to the plurality of dimensions includes one or more of: transactional data, promotional data, pricing data; tenure data; site data, product data, seasonal data, and lifecycle data of a customer.

5. The computer-implemented method of claim 1, wherein the respective score for the each data subset of the plurality of data subsets is generated by concurrently processing the each data subset using the at least one statistical model or machine-learning based model.

6. The computer-implemented method of claim 1, wherein determining the respective LTV of the each customer of the plurality of customers further comprises:
selecting an extrapolation function based upon the survival probability of the each customer of the plurality of customers, wherein the extrapolation function includes one of: a sigmoid function or a negative exponential function; and
extrapolating the data corresponding to the plurality of dimensions to a future value using the selected extrapolation function.

7. The computer-implemented method of claim 1, wherein classifying the plurality of customers into the one or more groups of customers for the campaign by the client comprises:
computing a customer ability score (CAS) for the each customer of the plurality of customers, wherein the CAS is computed based upon the respective LTV of the each customer of the plurality of customers, the survival probability of the each customer of the plurality of customers, and a seasonality adjustment factor; and
segmenting, based on the CAS for the each customer of the plurality of customers, the plurality of customers into the one or more groups of customers for recommending actions to be taken to be taken to increase the long-term value of the campaign, wherein each of the one or more groups of customers is assigned with a priority value or a differential treatment.

8. The computer-implemented method of claim 1, wherein the plurality of factors comprises expected benefit of the campaign, a margin value to adjust the budget on a predefined margin, a priority of each group of the one or more groups of customers, a size of each of the one or more groups of customers, and a CAS corresponding to each group of the one or more groups of customers.

9. A server comprising:
at least one memory configured to store executable instructions; and
at least one processor communicatively coupled with the at least one memory and configured to execute the instructions to perform operations comprising:
identify, based on data corresponding to a plurality of dimensions, churn customers from a plurality of customers and expected time for the churn customers to churn from a system;
generate a plurality of data subsets from the data corresponding to the plurality of dimensions;
generate a respective score for each data subset of the plurality of data subsets by processing the each data subset using at least one statistical model or machine-learning based model for analyzing survival aspect of each customer of the plurality of customers, wherein the at least one statistical model or machine-learning based model is trained based on the identified churn customers and expected time for the churn customers;
compute a survival probability of the each customer of the plurality of customers, based upon a weighted average score, wherein the weighted average score is generated from the respective score for the each data subset;
determine a respective long-term value (LTV) of the each customer of the plurality of customers based on the survival probability of the each customers, a historical value, and a discount factor;
classifying, based on the LTV of the each customer, the plurality of customers into one or more groups of customers for a campaign by a client, wherein each of the one or more groups of customers is related to a theme;
identifying a budget of the campaign, based on the one or more groups of customers, and a plurality of factors; and
estimating, based upon the identified budget and the one or more groups of customers, long-term value and a short-term value of the campaign.

10. The server of claim 9, wherein identifying the churn customers and the expected time for the churn customers comprises:
monitoring one or more parameters for the each customer of the plurality of customers;
computing a ratio of increment to decrement based on the monitoring of the one or more parameters for the each customer; and
correlating the one or more parameters and the ratio of increment to decrement corresponding to an observation period to identify the churn customers and the expected time for the churn customers to churn from the system.

11. The server of claim 9, wherein the at least one statistical model or machine-learning based model includes a random forest model, a deep learning survival model, a cox proportional hazardous model, or a gradient boost model.

12. The server of claim 9, wherein the data corresponding to the plurality of dimensions includes one or more of: transactional data, promotional data, pricing data; tenure data; site data, product data, seasonal data, and lifecycle data of a customer.

13. The server of claim 9, wherein the respective score for the each data subset of the plurality of data subsets is generated by concurrently processing the each data subset using the at least one statistical model or machine-learning based model.

14. The server of claim 9, wherein determining the respective LTV of the each customer of the plurality of customers further comprises:
selecting an extrapolation function based upon the survival probability of the each customer of the plurality of customers, wherein the extrapolation function includes one of: a sigmoid function or a negative exponential function; and
extrapolating the data corresponding to the plurality of dimensions to a future value using the selected extrapolation function.

15. The server of claim 9, wherein classifying the plurality of customers into the one or more groups of customers for the campaign by the client comprises:
computing a customer ability score (CAS) for the each customer of the plurality of customers, wherein the CAS is computed based upon the respective LTV of the each customer of the plurality of customers, the survival probability of the each customer of the plurality of customers, and a seasonality adjustment factor; and
segmenting, based on the CAS, for the each customer of the plurality of customers, the plurality of customers into the one or more groups of customers for recommending actions to be taken to be taken to increase the long-term value of the campaign, wherein each of the one or more groups of customers is assigned with a priority value or a differential treatment.

16. The server of claim 9, wherein the plurality of factors comprises expected benefit of the campaign, a margin value to adjust the budget on a predefined margin, a priority of each group of the one or more groups of customers, a size of each of the one or more groups of customers, and a CAS corresponding to each group of the one or more groups of customers.

17. A non-transitory computer readable media (CRM) storing instructions thereon, which, when executed by at least one processor of a computing device, cause the computing device to perform operations comprising:
identifying, based on data corresponding to a plurality of dimensions, churn customers from a plurality of customers and expected time for the churn customers to churn from a system;
generating a plurality of data subsets from the data corresponding to the plurality of dimensions;
generating a respective score for each data subset of the plurality of data subsets by processing the each data subset using at least one statistical model or machine-learning based model for analyzing survival aspect of each customer of the plurality of customers, wherein the at least one statistical model or machine-learning based model is trained based on the identified churn customers and expected time for the churn customers;
computing a survival probability of the each customer of the plurality of customers, based upon a weighted average score, wherein the weighted average score is generated from the respective score for the each data subset;
determining a respective long-term value (LTV) of the each customer of the plurality of customers based on the survival probability of the each customers, a historical value, and a discount factor;
classifying, based on the respective LTV of the each customer, the plurality of customers into one or more groups of customers for a campaign by a client, wherein each of the one or more groups of customers is related to a theme;
identifying a budget of the campaign, based on the one or more groups of customers, and a plurality of factors; and
estimating, based upon the identified budget and the one or more groups of customers, long-term value and a short-term value of the campaign.

18. The non-transitory CRM of claim 17, wherein identifying the churn customers and the expected time for the churn customers comprises:
monitoring one or more parameters associated with the each customer of the plurality of customers;
computing a ratio of increment to decrement based on monitoring of the one or more parameters for the each customer; and
correlating the one or more parameters and the ratio of increment to decrement corresponding to an observation period to identify the churn customers and the expected time for the churn customers to churn from the system.

19. The non-transitory CRM of claim 17, wherein:
the at least one statistical model or machine-learning based model includes a random forest model, a deep learning survival model, a cox proportional hazardous model, or a gradient boost model;
the data corresponding to the plurality of dimensions includes one or more of: transactional data, promotional data, pricing data; tenure data; site data, product data, seasonal data, and lifecycle data of a customer;
the plurality of factors comprises expected benefit of the campaign, a margin value to adjust the budget on a predefined margin, a priority of each group of the one or more groups of customers, a size of each of the one or more groups of customers, and a CAS corresponding to each group of the one or more groups of customers;
determining the respective LTV of the each customer of the plurality of customers further comprises:
selecting an extrapolation function based upon the survival probability of the each customer of the plurality of customers, wherein the extrapolation function includes one of: a sigmoid function or a negative exponential function; and
extrapolating the data corresponding to the plurality of dimensions to a future value using the selected extrapolation function; and/or
the respective score for the each data subset of the plurality of data subsets is generated by concurrently processing the each data subset using the at least one statistical model or machine-learning based model.

20. The non-transitory CRM of claim 17, wherein classifying the plurality of customers into the one or more groups of customers for the campaign by the client comprises:
computing a customer ability score (CAS) for the each customer of the plurality of customers, wherein the CAS is computed based upon the respective LTV of the each customer of the plurality of customers, the survival probability of the each customer of the plurality of customers, and a seasonality adjustment factor; and
segmenting, based on the CAS, for the each customer of the plurality of customers, the plurality of customers into the one or more groups of customers for recommending actions to be taken to be taken to increase the long-term value of the campaign, wherein each of the one or more groups of customers is assigned with a priority value or a differential treatment.
